(19) United States
(12) Patent Application Publication
(10) Pub. No.: US 2022/0374018 A1
(43) Pub. Date: Nov. 24, 2022

(54) METHOD AND APPARATUS FOR CONTROLLING AUTOMATED GUIDED VEHICLE

(71) Applicant: Beijing Jingdong Qianshi Technology Co., Ltd., Beijing (CN)

(72) Inventor: Shumin ZHANG, Beijing (CN)

(21) Appl. No.: 17/767,304

(22) PCT Filed: Aug. 18, 2020
(86) PCT No.: PCT/CN2020/109799

§ 371 Date: Apr. 7, 2022

(30) Foreign Application Priority Data
Oct. 8, 2019 (CN) 201910949929.1

(51) Int. Cl. G05D 1/02

(52) U.S. Cl. CPC G05D 1/0217; G05D 1/0214; G05D 2201/0216

(57) ABSTRACT

Disclosed is a method for controlling an automated guided vehicle, comprising: if an item transportation request is received, planning a path of a target automated guided vehicle to obtain an initial path; and performing the following control steps on the basis of the initial path: taking at least part of the travel path from the initial path as the path to-be-traveled; controlling the target automated guided vehicle to travel according to the path to-be-traveled determining whether the end position of the path to-be-traveled is the target end position, and if the end position of the to-be-traveled path is not the target end position, re-planning the path of the target automated guided vehicle, and taking the updated path as the initial path to continue the control steps.

### CROSS-REFERENCE TO RELATED APPLICATIONS

This patent application claims the priority from Chinese Patent Application No. 201910949929.1, filed on Oct. 8, 2019, entitled “Method and Apparatus for Controlling Automated Guided Vehicle,” the entire disclosure of which is hereby incorporated by reference.

### TECHNICAL FIELD

Embodiments of the present disclosure relate to the field of computer technology, and particularly to a method and apparatus for controlling an automated guided vehicle.

### BACKGROUND

With the rapid development of e-commerce and new retail, AGV (automated guided vehicle) warehouses have been widely applied. A multi-depth AGV warehouse refers to that an AGV can only enter each storage position from one side of a storage position area to perform an item stock-in service, an item stock-out service, and an item stock-count service. In the multi-depth AGV warehouse, if the AGV needs to travel to a target storage position to transport or place goods, but there are already goods stored on other storage positions between a passage opening and a target storage location, at this time, the AGV needs to take the goods from the storage position where the goods are stored, and thus can be able to place the goods on the target storage position or take the goods away from the target storage position.

### SUMMARY

Embodiments of the present disclosure propose a method and apparatus for controlling an automated guided vehicle.

In a first aspect, an embodiment of the present disclosure provides a method for controlling an automated guided vehicle, including: planning, in response to receiving an item transportation request, a path of a target automated guided vehicle to obtain an initial path, the item transportation request comprising a target start point position and a target end point position; performing, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and using, in response to determining that the end point position of the to-be-traveled path is not the target end point position, a current position of the target automated guided vehicle as a start point position, to re-plan the path of the target automated guided vehicle to obtain an updated path, and using the updated path as the initial path to continue to perform the control steps.

In some embodiments, wherein the controlling the target automated guided vehicle to travel according to the to-be-traveled path includes: changing a state of the to-be-traveled path to an occupancy state; controlling the target automated guided vehicle to travel according to the to-be-traveled path; and changing a state of a path that the target automated guided vehicle travels through in the to-be-traveled path to a travelable state.

In some embodiments, wherein the taking, from the initial path, at least a partial travel path including a start point position of the initial path as a to-be-traveled path includes: determining, in response to determining that the initial path is in the target area, the initial path as the to-be-traveled path.

In some embodiments, wherein the taking, from the initial path, at least a partial travel path including a start point position of the initial path as a to-be-traveled path includes: determining, in response to determining that the initial path includes a path in the target area and a path outside the target area, whether the start point position of the initial path is in the target area or outside the target area; and taking, from the initial path, a path in the target area where the start point position of the initial path is, to use the path as the to-be-traveled path, in response to determining that the start point position of the initial path is in the target area.

In some embodiments, wherein, before the controlling the target automated guided vehicle to travel according to the to-be-traveled path, the method includes: determining, in response to determining that the to-be-traveled path is in the occupancy state, whether there is an other travelable path, based on the current position of the target automated guided vehicle, the target end point position and a state of each path in a preset first area; and adding, in response to determining that there is no other travelable path, an identifier of the target automated guided vehicle to a candidate vehicle identifier set.

In some embodiments, wherein the controlling the target automated guided vehicle to travel according to the to-be-traveled path includes: selecting, in response to determining that the to-be-traveled path is in a travelable state, a vehicle identifier meeting a preset condition from the candidate vehicle identifier set, and controlling an automated guided vehicle corresponding to the selected vehicle identifier to travel according to the to-be-traveled path.

In some embodiments, wherein, before the controlling the target automated guided vehicle to travel according to the to-be-traveled path, the method further includes: acquiring a to-be-traveled path of an other automated guided vehicle in a preset second area, the second area including the current position of the target automated guided vehicle; acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the states comprising an empty-load state and a load state; and using, if the target automated guided vehicle is in the empty-load state and the other automated guided vehicle is in the load state, the current position of the target automated guided vehicle as the start point position, to re-plan the path of the target automated guided vehicle to obtain the updated path, and using the updated path as the initial path to continue to perform the control steps.

In some embodiments, wherein, after the acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the method further includes: determining, if the target automated guided vehicle and the other automated guided vehicle are in the empty-load state, whether the coincident to-be-traveled paths are occupied by the other automated guided vehicle; and using, in response to determining that the coincident to-be-traveled paths are occupied by the other automated guided vehicle, the current position of the target automated guided vehicle as the start point position, to re-plan the path of the target automated guided vehicle to obtain the updated path, and using the updated path as the initial path to continue to perform the control steps.

In a second aspect, an embodiment of the present disclosure provides an apparatus for controlling an automated guided vehicle, including: a planning unit, configured to plan, in response to receiving an item transportation request, a path of a target automated guided vehicle to obtain an initial path, the item transportation request comprising a target start point position and a target end point position; a controlling unit, configured to perform, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and a feeding-back unit, configured to use, in response to determining that the end point position of the to-be-traveled path is not the target end point position, a current position of the target automated guided vehicle as a start point position, to re-plan the path of the target automated guided vehicle to obtain an updated path, and use the updated path as the initial path to continue to perform the control steps.

In a third aspect, an embodiment of the present disclosure provides an electronic device, including: one or more processors; and a storage apparatus, configured to store one or more programs. The one or more programs, when executed by the one or more processors, cause the one or more processors to implement the method according to any embodiment of the method for controlling an automated guided vehicle provided by the first aspect.

In a fourth aspect, an embodiment of the present disclosure provides a computer readable medium, storing a computer program. The program, when executed by a processor, implements the method according to any embodiment of the method for controlling an automated guided vehicle provided by the first aspect.

According to the method and apparatus for controlling an automated guided vehicle provided in the embodiments of the present disclosure, when the item transportation request is received, the path of the target automated guided vehicle is planned to obtain the initial path. Then, based on the initial path, the following control steps are performed: taking, from the initial path, at least the partial travel path including the start point position of the initial path as the to-be-traveled path; controlling the target automated guided vehicle to travel according to the to-be-traveled path; changing, in response to detecting that the target automated guided vehicle travels into the target area, the state of the target area to the occupancy state, the target area comprising at least one of the preset locked area and the area between the storage position and the preset passage opening; changing, in response to detecting that the target automated guided vehicle travels out of the target area, the state of the target area to the travelable state; and determining whether the end point position of the to-be-traveled path is the target end point position. If it is determined that the end point position of the to-be-traveled path is not the target end point position, the current position of the target automated guided vehicle is taken as the start point position, to re-plan the path of the target automated guided vehicle to obtain the updated path, and the updated path is used as the initial path to continue to perform the control steps. In this way, the target area can be dynamically adjusted. The state of the target area is changed to the occupancy state when the automated guided vehicle travels into the target area, and the state of the target area is changed to the travelable state when the automated guided vehicle travels into the target area. Accordingly, the time waste of the automated guided vehicle due to the vehicle avoidance can be avoided, thereby improving the transportation efficiency of the automated guided vehicle.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an exemplary system architecture in which various embodiments of the present disclosure may be applied;

FIG. 2 is a flowchart of an embodiment of a method for controlling an automated guided vehicle according to the present disclosure;

FIG. 3 is a schematic diagram of an application scenario in which the method for controlling an automated guided vehicle according to the present disclosure is applied to an item stock-in service;

FIG. 4 is a schematic diagram of an application scenario in which the method for controlling an automated guided vehicle according to the present disclosure is applied to an item stock-out service;

FIG. 5 is a flowchart of another embodiment of the method for controlling an automated guided vehicle according to the present disclosure;

FIG. 6 is a schematic structural diagram of an embodiment of an apparatus for controlling an automated guided vehicle according to the present disclosure; and

FIG. 7 is a schematic structural diagram of a computer system of an electronic device adapted to implement embodiments of the present disclosure.

### DETAILED DESCRIPTION OF EMBODIMENTS

The present disclosure is further described below in detail by combining the accompanying drawings and the embodiments. It may be appreciated that the particular embodiments described herein are merely used for explaining the relevant disclosure, rather than limiting the disclosure. In addition, it should also be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

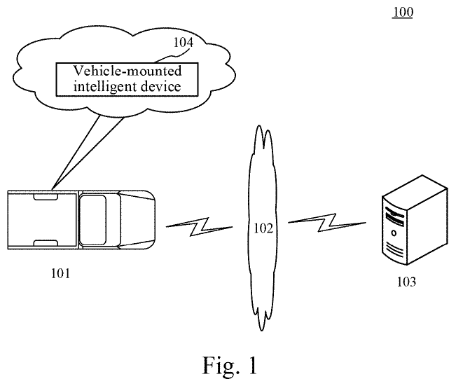

FIG. 1 illustrates an exemplary system architecture 100 in which an embodiment of a method for controlling an automated guided vehicle according to the present disclosure may be applied.

As shown in FIG. 1, the system architecture 100 may include an automated guided vehicle 101, a network 102, and a server 103 providing support for the automated guided vehicle 101. In the automated guided vehicle 101, a vehicle-mounted intelligent device 104 may be provided. The network 102 serves as a medium providing a communication link between the vehicle-mounted intelligent device 104 and the server 103. The network 102 may include various types of connections, for example, wired or wireless communication links, global positioning systems or optical fiber cables.

The control system of the automated guided vehicle 101 is installed on the vehicle-mounted intelligent device 104. The control system may control the running of the automated guided vehicle 101. The vehicle-mounted intelligent device 104 may interact with the server 103 through the network 102, to receive information such as control instructions (e.g., running instructions).

Various sensors such as an obstacle sensor, a camera apparatus, a gyroscope, an accelerometer may also be installed on the automated guided vehicle 101. It should be noted that the automated guided vehicle 101 may also be installed with sensors of various types and functions other than the above listed sensors, which will not be repeatedly described here.

A user may use the automated guided vehicle 101 to interact with the server 103 via the network 102 to receive or send a message, etc. Various communication client applications (e.g., a webpage browser application, a shopping application, a search application, an instant communication tool, a mailbox client and social platform software) may be installed on the automated guided vehicle 101.

The vehicle-mounted intelligent device 104 may be hardware or software. When being the hardware, the vehicle-mounted intelligent device 104 may be an electronic device supporting an information interaction. When being the software, the vehicle-mounted intelligent device 104 may be installed in the above electronic device. The vehicle-mounted intelligent device may be implemented as a plurality of pieces of software or a plurality of software modules (e.g., software or software modules for providing a distributed service), or as a single piece of software or a single software module, which will not be particularly defined here.

The server 103 may be a server providing various services, for example, a server sending a control instruction to the vehicle-mounted intelligent device 104 installed on the automated guided vehicle 101. If the server 103 receives an item transportation request, the server 103 may plan a path of the automated guided vehicle 101 to obtain an initial path. Then, based on the initial path, the server 103 may perform following control steps: taking, from the initial path, at least a partial travel path including a start point position of the initial path as a to-be-traveled path; controlling the automated guided vehicle 101 to travel according to the to-be-traveled path; changing, in response to detecting that the automated guided vehicle 101 travels into a target area, a state of the target area to an occupancy state; changing, in response to detecting that the automated guided vehicle 101 travels out of the target area, the state of the target area to a travelable state; and determining whether an end point position of the to-be-traveled path is a target end point position. Finally, if the server 103 determines that the end point position of the to-be-traveled path is not the target end point position, the server 103 may use a current position of the automated guided vehicle 101 as a start point position, to re-plan the path of the automated guided vehicle 101 to obtain an updated path, and use the updated path as the initial path to continue to perform the control steps.

It should be noted that the server 103 may be hardware or software. When being the hardware, the server 103 may be implemented as a distributed server cluster composed of a plurality of servers, or as a single server. When being the software, the server 103 may be implemented as a plurality of pieces of software or a plurality of software modules (e.g., software or software modules for providing a distributed service), or as a single piece of software or a single software module, which will not be particularly defined here.

It should be noted that the method for controlling an automated guided vehicle provided by the embodiments of the present disclosure is generally performed by the server 103.

It should be appreciated that the numbers of the automated guided vehicles, the vehicle-mounted intelligent devices, the networks and the servers in FIG. 1 are merely illustrative. Any number of automated guided vehicles, vehicle-mounted intelligent devices, networks and servers may be provided based on actual requirements.

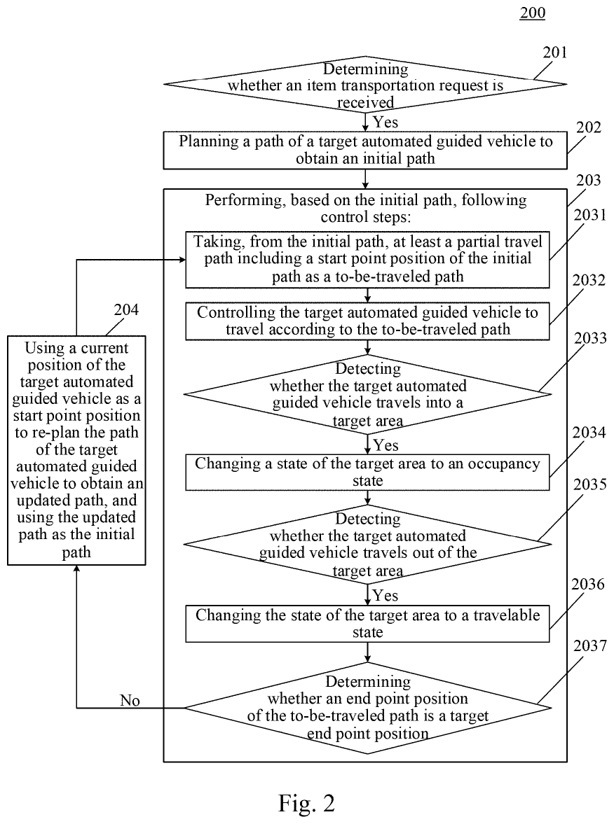

Further referring to FIG. 2, FIG. 2 illustrates a flow 200 of an embodiment of a method for controlling an automated guided vehicle according to the present disclosure. The method for controlling an automated guided vehicle includes the following steps.

Step 201, determining whether an item transportation request is received.

In this embodiment, an executing body (e.g., the server shown in FIG. 1) of the method for controlling an automated guided vehicle may determine whether the item transportation request is received. Here, the above item transportation request may include a target start point position and a target end point position. The above target start point position is generally the coordinates of a start point position, and the above target end point position is generally the coordinates of an end point position.

Here, the above item transportation request may further include a transportation service type, and an item transportation service may include, but not limited to, an item stock-in service, an item stock-out service, and an item stock-count service. The item stock-in service refers to that an item is transported from a stock-in temporary storage position or a stock-in lifter temporary storage position to the storage position corresponding to the item, and placed on a shelf. The item stock-out service refers to that the item is transported from the storage position corresponding to the item to a stock-out temporary storage position or a stock-out lifter temporary storage position, and is picked and taken away from the shelf. The item stock-count service refers to that the item is transported from the storage position to a stock-count station, to count the actual number of stock items.

In a warehouse management system, the storage position refers to the position used to keep or store an item. The stock-in temporary storage position refers to the position where the item is temporarily stored when arriving at the warehouse and waiting to be transported to the corresponding storage position. In a multi-storey storage warehouse, if the storage position corresponding to the item is on the second floor or above, at this time, it is required to set the stock-in lifter temporary storage position. The stock-in lifter temporary storage position refers to the position where the item is temporarily stored when arriving at the warehouse and waiting to be transported to the corresponding storage position, the position being set on the corresponding floor. The stock-out temporary storage position refers to the position where the item is temporarily stored during waiting for stock-out. In the multi-storey storage warehouse, if the storage position corresponding to the item is on the second floor or above, at this time, it is required to set the stock-out lifter temporary storage position. The stock-out lifter temporary storage position refers to the position where the item is temporarily stored during waiting for stock-out, the position being set on the corresponding floor. The stock-count station refers to the position point where the actual number of stock items is counted.

As an example, in the item stock-in service, the above target start point position is usually the stock-in temporary storage position or the stock-in lifter temporary storage position, and the above target end position is usually the storage position corresponding to the item. In the item stock-out service, the above target start point position is usually the storage position corresponding to the item, and the target end point position is usually the stock-out temporary storage position or the stock-out lifter temporary storage position. In the item stock-count service, the above target start point is usually the storage position corresponding to the item, and the above target end position is usually the stock-count station.

Here, the above item transportation request may be sent by a terminal device. After viewing an order request or a replenishment request, a warehouse management personnel may use the terminal device to send the item transportation request including the coordinates of the start point position and the coordinates of the end point position to the above executing body.

Step 202, planning, in response to receiving the item transportation request, a path of a target automated guided vehicle to obtain an initial path.

In this embodiment, if it is determined in step 201 that the item transportation request is received, the above executing body may plan the path of the target automated guided vehicle to obtain the initial path. The automated guided vehicle may also be called an automatic guided vehicle, which refers to a transportation vehicle that is equipped with an automatic guided apparatus such as an electromagnetic or optical guided apparatus and that can travel along a prescribed guide path and has a safety protection function and various transfer functions. Here, the automated guided vehicle is usually a four-way automated guided vehicle. On the basis of an ordinary automated guided vehicle, the four-way automated guided vehicle can move laterally and can reach a designated position along a track. The above target automated guided vehicle may be an automated guided vehicle currently in an idle state, or may be an automated guided vehicle corresponding to the transported item.

In this embodiment, the above executing body may plan the path of the above target automated guided vehicle in the following way:

First, environment modeling. Environment modeling is an important part of path planning. The purpose of the environment modeling is to establish an environment model that is convenient for a computer to use to perform path planning, that is, to abstract the actual physical space into an abstract space that can be processed by an algorithm, realizing mutual mapping.

Then, path searching. In the path searching stage, a corresponding algorithm is applied on the basis of the environment model to find a walking path, such that a predetermined performance function obtains an optimal value. Here, an algorithm such as a Dijkstra's algorithm or a genetic algorithm may be used to search the path. Here, the Dijkstra's algorithm is an algorithm of calculating the shortest path from one vertex to other vertices, and accordingly, what the algorithm solves is the problem of the shortest path in a weighted graph. The genetic algorithm is a method of searching an optimal solution by simulating a natural evolution process.

Finally, path smoothing. The path searched by the corresponding algorithm is not necessarily a travelable path that a moving object can travel on, and needs to be further processed and smoothed to make the path become a practical path.

Step 203, performing, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state; changing, in response to detecting that the target automated guided vehicle travels out of the target area, the state of the target area to a travelable state; and determining whether an end point position of the to-be-traveled path is a target end point position.

In this embodiment, the above executing body may perform the control steps based on the initial path generated in step 202 and the initial path fed back in step 204.

In this embodiment, step 203 may include sub-steps 2031, 2032, 2033, 2034, 2035, 2036 and 2037. Here,

Step 2031, taking, from the initial path, at least the partial travel path including the start point position of the initial path as the to-be-traveled path.

In this embodiment, the above executing body may take, from the initial path generated in step 202 or the initial path fed back in step 204, at least the partial travel path including the start point position of the initial path as the to-be-traveled path. That is, the above executing body may start from the start point position of the above initial path to take at least the partial travel path.

As an example, the above executing body may start from the start point position of the above initial path to take at least the partial travel path of a preset length (e.g., 5 meters and 10 meters). It should be noted that, if the path length of the above initial path is less than the above preset length, the above initial path may be determined as the to-be-traveled path; and if the path length of the above initial path is greater than the above preset length, the partial travel path of the preset length may be taken from the above initial path to be used as the to-be-traveled path.

As another example, the above executing body may store a layout diagram of a warehouse. In the layout diagram of the warehouse, a plurality of points may be preset, and each point corresponds to one preset area of the warehouse. The above executing body may start from the start point position of the above initial path to take a travel path corresponding to a preset number of points as the to-be-traveled path. It should be noted that the distance between two points in the layout diagram of the warehouse may not be fixed, and the points in the layout diagram of the warehouse may be set according to the particular environmental information in the warehouse.

Step 2032, controlling the target automated guided vehicle to travel according to the to-be-traveled path.

In this embodiment, the above executing body may control the above target automated guided vehicle to travel according to the to-be-traveled path taken in step 2031. Particularly, the above executing body may send a control instruction corresponding to the above to-be-traveled path to the above target automated guided vehicle. The above control instruction may include, but not limited to, at least one of: a travel direction, a travel speed and a rotation angle.

Step 2033, detecting whether the target automated guided vehicle travels into the target area.

In this embodiment, the above executing body may detect whether the above target automated guided vehicle travels into the target area. The above target area may include at least one of: a preset locked area, and an area between the storage position and a preset passage opening. The above locked area may generally be an area with only one entrance and exit that is set by people. The passage opening may refer to the last position point in the passage area in front of the storage position area.

In this embodiment, the above executing body may store position information (e.g., coordinates of positions) of the above target area. The above target automated guided vehicle may send the current position of the vehicle to the above executing body during traveling, and the above executing body may determine whether the current position of the vehicle is in the above target area. If it is determined that the current position of the vehicle is in the above target area, it can be detected that the above target automated guided vehicle travels into the above target area.

Step 2034, changing, in response to detecting that the target automated guided vehicle travels into the target area, the state of the target area to the occupancy state.

In this embodiment, if it is detected in step 2033 that the above target automated guided vehicle travels into the above target area, the above executing body may change the state of the above target area to the occupancy state. It should be noted that the occupancy state here refers to that the above target area is occupied by the above target automated guided vehicle, and an other automated guided vehicle other than the above target automated guided vehicle cannot travel into the target area.

Step 2035, detecting whether the target automated guided vehicle travels out of the target area.

In this embodiment, the above executing body may detect whether the above target automated guided vehicle travels out of the above target area. The above executing body may determine whether the current position of the vehicle is outside the above target area. If it is determined that the current position of the vehicle is outside the above target area, it can be detected that the above target automated guided vehicle travels out of the above target area.

Step 2036, changing, in response to detecting that the target automated guided vehicle travels out of the target area, the state of the target area to the travelable state.

In this embodiment, if it is detected in step 2035 that the above target automated guided vehicle travels out of the above target area, the above executing body may change the state of the above target area to the travelable state. At this time, the other automated guided vehicle may travel into the target area.

Step 2037, determining whether the end point position of the to-be-traveled path is the target end point position.

In this embodiment, the above executing body may determine whether the end point position of the above to-be-traveled path is the above target end point position.

Step 204, using, in response to determining that the end point position of the to-be-traveled path is not the target end point position, a current position of the target automated guided vehicle as a start point position, to re-plan the path of the target automated guided vehicle to obtain an updated path, and using the updated path as the initial path to continue to perform the control steps.

In this embodiment, if it is determined in step 2037 that the end point position of the above to-be-traveled path is not the above target end point position, the above executing body may use the current position of the above target automated guided vehicle as the start point position, to re-plan the path of the target automated guided vehicle to obtain the updated path. Particularly, the above executing body may re-plan the path by using the algorithm such as the Dijkstra's algorithm or the genetic algorithm. Here, the Dijkstra's algorithm is an algorithm of calculating the shortest path from one vertex to other vertices, and accordingly, what the algorithm solves is the problem of the shortest path in a weighted graph. The genetic algorithm is a method of searching an optimal solution by simulating a natural evolution process. Then, the above executing body may use the above updated path as the initial path to continue to perform the control steps 2031-2037.

In some alternative implementations of this embodiment, the above executing body may control, in the following way, the above target automated guided vehicle to travel according to the above to-be-traveled path. The above executing body may first change the state of the above to-be-traveled path to an occupancy state. It should be noted that the occupancy state here refers to that the above to-be-traveled path is occupied by the above target automated guided vehicle, and an other automated guided vehicle other than the above target automated guided vehicle cannot travel into the above to-be-traveled path. Then, the above executing body may control the above target automated guided vehicle to travel according to the above to-be-traveled path. Particularly, the above executing body may send a control instruction corresponding to the above to-be-traveled path to the above target automated guided vehicle, and the above control instruction may include, but not limited to, at least one of: a travel direction, a travel speed and a rotation angle. Then, the above executing body may change the state of the path that the above target automated guided vehicle travels through in the above to-be-traveled path to a travelable state. Here, the above executing body may store a layout diagram of a warehouse. In the layout diagram of the warehouse, a plurality of points may be preset, and each point corresponds to one preset first area of the warehouse. When the above target automated guided vehicle travels according to the above to-be-traveled path, every time the above target automated guided vehicle travels through a point, the above executing body may change the state of the preset first area corresponding to the point to the travelable state. At this time, the other automated guided vehicle can travel into the target area.

In some alternative implementations of this embodiment, in the following way, the above executing body may take, from the above initial path, at least the partial travel path including the start point position of the above initial path as the to-be-traveled path. The above executing body may determine whether the above initial path is in the above target area. Here, determining whether the above initial path is in the above target area is generally to determine whether the whole initial path is in the above target area. If it is determined that the above initial path is in the above target area, the above executing body may determine the above initial path as the to-be-traveled path.

In some alternative implementations of this embodiment, in the following way, the above executing body may take, from the above initial path, at least the partial travel path including the start point position of the above initial path as the to-be-traveled path. The above executing body may determine whether the above initial path includes a path in the above target area and includes a path outside the above target area. If it is determined that the above initial path includes the path in the above target area and includes the path outside the above target area, the above executing body may determine whether the start point position of the above initial path is in the above target area or outside the above target area. If it is determined that the start point position of the above initial path is in the above target area, the above executing body may take, from the above initial path, a path in the target area where the start point position of the above initial path is, to use the path as the to-be-traveled path.

In some alternative implementations of this embodiment, the above executing body may determine whether the above to-be-traveled path is in an occupancy state. It should be noted that the occupancy state here refers to that the above to-be-traveled path is occupied by an other target automated guided vehicle, which causes the above target automated guided vehicle to be unable to travel into the above to-be-traveled path. If it is determined that the above to-be-traveled path is in the occupancy state, the above executing body may determine whether there is an other travelable path, based on the current position of the above target automated guided vehicle, the above target end point position, and the state of each path in the preset first area. The above preset first area may be an area including various paths from the current position of the above target automated guided vehicle to the above target end point position. Particularly, the above executing body may first determine at least one path from the current position of the above target automated guided vehicle to the above target end point position. Then, the above executing body may select, from the at least one path, an other path not including the above travelable path. Next, the above executing body may determine whether the state of the other path is an occupancy state. If the state of the other path is the occupancy state, the above executing body may determine whether the occupancy waiting time of the other path is greater than the occupancy waiting time of the above travel path. If it is determined that the occupancy waiting time of the other path is greater than the occupancy waiting time of the above travel path, the above executing body may determine that there is no other travelable path. At this time, the identifier of the above target automated guided vehicle may be added to a candidate vehicle identifier set. The vehicle identifier in the above candidate vehicle identifier set is a vehicle identifier of an automated guided vehicle that is waiting because the above to-be-traveled path is occupied by an other automated guided vehicle.

In some alternative implementations of this embodiment, the above executing body may control, in the following way, the above target automated guided vehicle to travel according to the above to-be-traveled path. The above executing body may determine whether the state of the above to-be-traveled path is a travelable state. If it is determined that the above to-be-traveled path is changed from the occupancy state to the travelable state, the above executing body may select, from the above candidate vehicle identifier set, a vehicle identifier meeting a preset condition. The above executing body may select, from the above candidate vehicle identifier set, the vehicle identifier of an automated guided vehicle of which the waiting time is longest. The above executing body may alternatively select, from the above candidate vehicle identifier set, the vehicle identifier of an automated guided vehicle with a highest priority. In order to ensure the timeliness of an order, a priority may be set for the automated guided vehicle transporting an item. Then, the above executing body may control the automated guided vehicle corresponding to the selected vehicle identifier to travel according to the above to-be-traveled path.

According to the method provided in the above embodiment of the present disclosure, by changing the state of the target area to the occupancy state when the automated guided vehicle travels into the target area, and changing the state of the target area to the travelable state when the automated guided vehicle travels into the target area, the time waste of the automated guided vehicle due to the vehicle avoidance can be avoided, thereby improving the transportation efficiency of the automated guided vehicle.

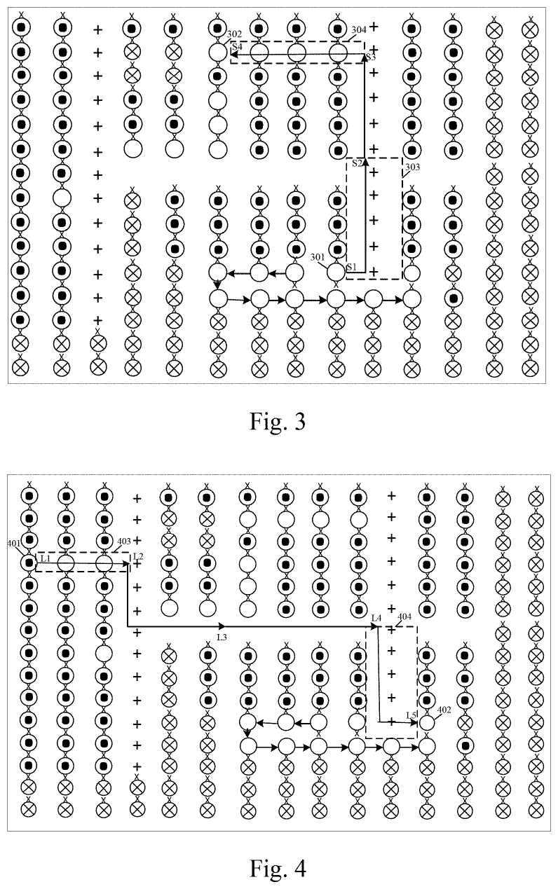

As an example, as shown in FIG. 3, FIG. 3 is a schematic diagram of an application scenario in which the method for controlling an automated guided vehicle according to this embodiment is applied to an item stock-in service. First, if a server for controlling an automated guided vehicle receives an item transportation request to transport an item from a target start point position 301 to a target end point position 302, a path of a target automated guided vehicle may be planned to obtain an initial path. Here, the target start point position 301 is a stock-in temporary storage position or a stock-in lifter temporary storage position, and the target end point position 302 is a storage position of the item.

Afterwards, the above server may take, from the initial path, the path from a point S1 to a point S2 as a to-be-traveled path, and control the above target automated guided vehicle to travel according to the path from the point S1 to the point S2. The path from the point S1 to the point S2 is inside a target area 303, and at this time, it is detected that the above target automated guided vehicle travels into the target area 303. Thus, the state of the target area 303 may be changed to an occupancy state. If the above target automated guided vehicle travels to the point S2, the above server detects that the above target automated guided vehicle travels out of the target area 303, and thus may change the state of the target area 303 to a travelable state. Then, whether the end point position (the point S2) of the path from the point S1 to the point S2 is the target end point position 302 may be determined. At this time, if it is determined that the end point position of the path from the point S1 to the point S2 is not the target end point position 302, the point S2 may be used as the start point position to re-plan the path of the above target automated guided vehicle to obtain an updated path as the initial path.

Then, the above server may take, from the initial path, a travel path corresponding to five points as the to-be-traveled path. Here, the travel path corresponding to the five points is the path from the point S2 to a point S3. The above server may change the state of the path from the point S2 to the point S3 to an occupancy state, and then may control the above target automated guided vehicle to travel according to the path from the point S2 to the point S3. Every time the above target automated guided vehicle travels through a point, the above server may change the state of the point the vehicle travels through to a travelable state, until the above target automated guided vehicle travels to the point S3. Then, whether the end point position (the point S3) of the path from the point S2 to the point S3 is the target end point position 302 may be determined. At this time, if it is determined that the end point position of the path from the point S2 to the point S3 is not the target end point position 302, the point S3 may be used as the start point position to re-plan the path of the above target automated guided vehicle to obtain an updated path as the initial path.

Then, the above server may take, from the initial path, a travel path from the point S3 to a point S4 as the to-be-traveled path, and control the above target automated guided vehicle to travel according to the path from the point S3 to the point S4. The path from the point S3 to the point S4 is inside a target area 304, and at this time, it is detected that the above target automated guided vehicle travels into the target area 304. Thus, the state of the target area 304 may be changed to an occupancy state. If the above target automated guided vehicle travels to the point S4, the above server detects that the above target automated guided vehicle travels out of the target area 304, and thus may change the state of the target area 304 to a travelable state. Then, whether the end point position (the point S4) of the path from the point S3 to the point S4 is the target end point position 302 may be determined. At this time, if it is determined that the end point position of the path from the point S3 to the point S4 is the target end point position 302, it indicates that the above target automated guided vehicle reaches the target end point position, and accordingly, the above target automated guided vehicle may place the transported item on the storage position.

As another example, as shown in FIG. 4, FIG. 4 is a schematic diagram of an application scenario in which the method for controlling an automated guided vehicle according to this embodiment is applied to an item stock-out service. First, if a server for controlling an automated guided vehicle receives an item transportation request to transport an item from a target start point position 401 to a target end point position 402, a path of a target automated guided vehicle may be planned to obtain an initial path. Here, the target start point position 401 is a storage position of the item, and the target end point position 402 is a stock-out temporary storage position or a stock-out lifter temporary storage position.

Afterwards, the above server may take, from the initial path, the path from a point L1 to a point L2 as a to-be-traveled path, and control the above target automated guided vehicle to travel according to the path from the point L1 to the point L2. The path from the point L1 to the point L2 is inside a target area 403, and at this time, it is detected that the above target automated guided vehicle travels into the target area 403. Thus, the state of the target area 403 may be changed to an occupancy state. If the above target automated guided vehicle travels to the point L2, the above server detects that the above target automated guided vehicle travels out of the target area 403, and thus may change the state of the target area 403 to a travelable state. Then, whether the end point position (the point L2) of the path from the point L1 to the point L2 is the target end point position 402 may be determined. At this time, if it is determined that the end point position of the path from the point L1 to the point L2 is not the target end point position 402, the point L2 may be used as the start point position to re-plan the path of the above target automated guided vehicle to obtain an updated path as the initial path.

Then, the above server may take, from the initial path, a travel path corresponding to five points as the to-be-traveled path. Here, the travel path corresponding to the five points is the path from the point L2 to a point L3. The above server may change the state of the path from the point L2 to the point L3 to an occupancy state, and then may control the above target automated guided vehicle to travel according to the path from the point L2 to the point L3. Every time the above target automated guided vehicle travels through a point, the above server may change the state of the point the vehicle travels through to a travelable state, until the above target automated guided vehicle travels to the point L3. Then, whether the end point position (the point L3) of the path from the point L2 to the point L3 is the target end point position 402 may be determined. At this time, if it is determined that the end point position of the path from the point L2 to the point L3 is not the target end point position 402, the point L3 may be used as the start point position to re-plan the path of the above target automated guided vehicle to obtain an updated path as the initial path.

Then, the above server may take, from the initial path, a travel path corresponding to five points as the to-be-traveled path. Here, the travel path corresponding to the five points is the path from the point L3 to a point L4. The above server may change the state of the path from the point L3 to the point L4 to an occupancy state, and then may control the above target automated guided vehicle to travel according to the path from the point L3 to the point L4. Every time the above target automated guided vehicle travels through a point, the above server may change the state of the point the vehicle travels through to a travelable state, until the above target automated guided vehicle travels to the point L4. Then, whether the end point position (the point L4) of the path from the point L3 to the point L4 is the target end point position 402 may be determined. At this time, if it is determined that the end point position of the path from the point L3 to the point L4 is not the target end point position 402, the point L4 may be used as the start point position to re-plan the path of the above target automated guided vehicle to obtain an updated path as the initial path.

Finally, the above server may take, from the initial path, a travel path from the point L4 to a point L5 as the to-be-traveled path, and control the above target automated guided vehicle to travel according to the path from the point L4 to the point L5. The path from the point L4 to the point L5 is inside a target area 404, and at this time, it is detected that the above target automated guided vehicle travels into the target area 404. Thus, the state of the target area 404 may be changed to an occupancy state. If the above target automated guided vehicle travels to the point L5, the above server detects that the above target automated guided vehicle travels out of the target area 404, and thus may change the state of the target area 404 to a travelable state. Then, whether the end point position (the point L5) of the path from the point L4 to the point L5 is the target end point position 402 may be determined. At this time, if it is determined that the end point position of the path from the point L4 to the point L5 is the target end point position 402, it indicates that the above target automated guided vehicle reaches the target end point position, and accordingly, the above target automated guided vehicle may place the transported item on the stock-out temporary storage position or the stock-out lifter temporary storage position.

It should be noted that, the application scenario of an item stock-count service usually includes a scenario where the item is transported from the corresponding storage position to the stock-count station, and a scenario where the item is transported from the stock-count station to the corresponding storage position. In the process of transporting the item from the corresponding storage position to the stock-count station, the server for controlling the automated guided vehicle may control the automated guided vehicle using a method similar to the control method described in the application scenario of the item stock-out service, which will not be repeatedly described here. In the process of transporting the item from the stock-count station to the corresponding storage position, the server for controlling the automated guided vehicle may control the automated guided vehicle using a method similar to the control method described in the application scenario of the item stock-in service, which will not be repeatedly described here.

It should also be noted that, in the application scenario of the item stock-in business, after placing the transported item on the corresponding storage position, the above target automated guided vehicle may request parking, that is, make a request to travel from the above storage position to a preset parking place of the automated guided vehicle. At this time, the server for controlling the automated guided vehicle may control the automated guided vehicle using the method similar to the control method described in the application scenario of the item stock-out service, which will not be repeatedly described here.

It should also be noted that, in the application scenario of the item stock-out business, the above target automated guided vehicle needs to first arrive at the storage position corresponding to the item, that is, make a request to travel from the preset parking place of the automated guided vehicle to the above storage position corresponding to the item. At this time, the server for controlling the automated guided vehicle may control the automated guided vehicle using the method similar to the control method described in the application scenario of the item stock-in service, which will not be repeatedly described here.

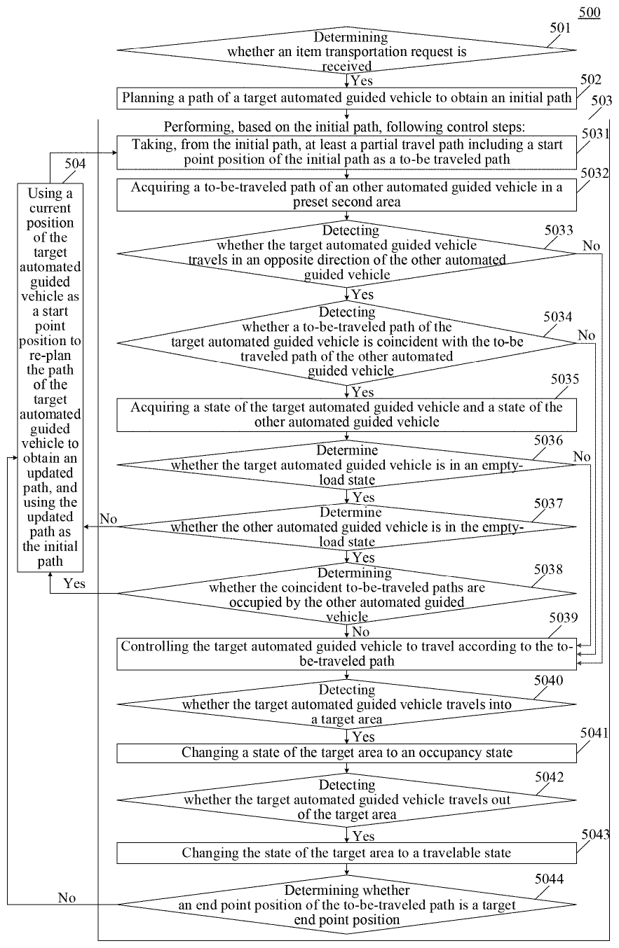

Further referring to FIG. 5, FIG. 5 illustrates a flow 500 of another embodiment of a method for controlling an automated guided vehicle. The flow 500 of the method for controlling an automated guided vehicle includes the following steps.

Step 501, determining whether an item transportation request is received.

Step 502, planning, in response to receiving the item transportation request, a path of a target automated guided vehicle to obtain an initial path.

In this embodiment, steps 501-502 may be performed in a way similar to steps 201-202, and thus will not be repeatedly described here.

Step 503, performing, based on the initial path, following control steps 5031-5044.

In this embodiment, the above executing body may perform the control steps based on the initial path generated in step 502 and the initial path fed back in step 504.

In this embodiment, step 503 may include sub-steps 5031, 5032, 5033, 5034, 5035, 5036, 5037, 5038, 5039, 5040, 5041, 5042, 5043 and 5044. Here,

Step 5031, taking, from the initial path, at least a partial travel path including a start point position of the initial path as a to-be-traveled path.

In this embodiment, step 5031 may be performed in a way similar to step 2031, and thus will not be repeatedly described here.

Step 5032, acquiring a to-be-traveled path of an other automated guided vehicle in a preset second area.

In this embodiment, the above executing body may acquire the to-be-traveled path of the other automated guided vehicle in the preset second area. Here, the above second area may include the current position of the above target automated guided vehicle. As an example, the above second area may be an area with the current position of the above target automated guided vehicle as a center point and a preset distance (e.g., 5 meters) as a radius. The above other automated guided vehicle may be an automated guided vehicle other than the above target automated guided vehicle in the above second area.

Step 5033, detecting whether the target automated guided vehicle travels in an opposite direction of the other automated guided vehicle.

In this embodiment, the above executing body may detect whether the above target automated guided vehicle travels in the opposite direction of the other automated guided vehicle. Traveling in the opposite direction means that the directions in which the above target automated guided vehicle and the above other automated guided vehicle travel are opposite. If it is detected that the above target automated guided vehicle travels in the opposite direction of the above other automated guided vehicle, the above executing body may perform step 5034. If it is detected that the above target automated guided vehicle does not travel in the opposite direction of the above other automated guided vehicle, the above executing body may perform step 5039.

Step 5034, detecting, in response to detecting that the target automated guided vehicle travels in the opposite direction of the other automated guided vehicle, whether the to-be-traveled path of the target automated guided vehicle is coincident with the to-be-traveled path of the other automated guided vehicle.

In this embodiment, if it is detected in step 5033 that the above target automated guided vehicle travels in the opposite direction of the above other automated guided vehicle, the above executing body may detect whether the to-be-traveled path of the above target automated guided vehicle is coincident with the to-be-traveled path of the above other automated guided vehicle. Here, the path coincidence may refer to a complete coincidence of the paths or a partial coincidence of the paths. If the above target automated guided vehicle travels in the opposite direction of the above other automated guided vehicle and the paths are coincident, it can indicate that the above target automated guided vehicle and the above other automated guided vehicle will have a head-on collision at some point in the future. If it is detected that the above target automated guided vehicle travels in the opposite direction of the above other automated guided vehicle and the to-be-traveled path of the above target automated guided vehicle is coincident with the to-be-traveled path of the above other automated guided vehicle, the above executing body may perform step 5035. If it is detected that the to-be-traveled path of the above target automated guided vehicle is not coincident with the to-be-traveled path of the above other automated guided vehicle, the above executing body may perform step 5039.

Step 5035, acquiring, in response to detecting that the target automated guided vehicle travels in the opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle.

In this embodiment, if it is detected in step 5034 that the above target automated guided vehicle travels in the opposite direction of the above other automated guided vehicle and the to-be-traveled path of the above target automated guided vehicle is coincident with the to-be-traveled path of the above other automated guided vehicle, the above executing body may acquire the state of the above target automated guided vehicle and the state of the above other automated guided vehicle. Here, the above states may include an empty-load state and a load state. The empty-load state refers to that the automated guided vehicle is not loaded with goods, and the automated guided vehicle from which the goods are unloaded or to which the goods are about to be loaded is generally in the empty-load state.

It should be noted that, in the application scenario of an item stock-in service, in the process of transporting an item from a stock-in temporary storage position or a stock-in lifter temporary storage position to a storage position corresponding to the item, the automated guided vehicle is generally in the load state. After the item is placed on the shelf, the automated guided vehicle is generally in the empty-load state in the process of traveling from the storage position to a parking place of the automated guided vehicle. In the application scenario of an item stock-out service, in the process of transporting the item from the storage position corresponding to the item to a stock-out temporary storage position or a stock-out lifter temporary storage position, the automated guided vehicle is generally in the load state. After the transportation is completed, the automated guided vehicle is generally in the empty-load state in the process of traveling from the stock-out temporary storage position or the stock-out lifter temporary storage position to the parking place of the automated guided vehicle. In the application scenario of an item stock-count service, the automated guided vehicle is generally in the load state in the process of transporting the item from the storage position to a stock-count station and in the process of transporting the item from the stock-count station to the storage position corresponding to the item.

Step 5036, determining whether the target automated guided vehicle is in an empty-load state.

In this embodiment, the above executing body may determine whether the above target automated guided vehicle is in the empty-load state. If it is determined that the above target automated guided vehicle is in the empty-load state, the above executing body may perform step 5037. If it is determined that the above target automated guided vehicle is in the load state, the above executing body may perform step 5039.

Step 5037, determining, in response to determining that the target automated guided vehicle is in the empty-load state, whether the other automated guided vehicle is in the empty-load state.

In this embodiment, if it is determined in step 5036 that the above target automated guided vehicle is in the empty-load state, the above executing body may determine whether the above other automated guided vehicle is in the empty-load state. If the above target automated guided vehicle and the above other automated guided vehicle are both in the empty-load state, the above executing body may perform step 5038.

Step 5038, determining, if the target automated guided vehicle and the other automated guided vehicle are in the empty-load state, whether the coincident to-be-traveled paths are occupied by the other automated guided vehicle.

In this embodiment, if it is determined in step 5037 that the above target automated guided vehicle and the above other automated guided vehicle are both in the empty-load state, the above executing body may determine whether the coincident to-be-traveled paths are occupied by the above other automated guided vehicle. That is, if the time at which the to-be-traveled path of the above other automated guided vehicle is occupied by the above other automated guided vehicle is earlier than the time at which the to-be-traveled path of the above target automated guided vehicle is occupied by the above target automated guided vehicle, it can indicate that the coincident to-be-traveled paths are occupied by the above other automated guided vehicle. If it is determined that the coincident to-be-traveled paths are not occupied by the other automated guided vehicle, step 5039 may be performed. If it is determined that the coincident to-be-traveled paths are occupied by the other automated guided vehicle, step 504 may be performed.

Step 5039, controlling the target automated guided vehicle to travel according to the to-be-traveled path, if it is detected in step 5033 that the target automated guided vehicle does not travel in the opposite direction of the other automated guided vehicle, detected in step 5034 that the to-be-traveled path of the target automated guided vehicle is not coincident with the to-be-traveled path of the other automated guided vehicle, or determined in step 5036 that the target automated guided vehicle is not in the empty-load state.

In this embodiment, if it is detected in step 5033 that the above target automated guided vehicle does not travel in the opposite direction of the above other automated guided vehicle, it is detected in step 5034 that the to-be-traveled path of the above target automated guided vehicle is not coincident with the to-be-traveled path of the above other automated guided vehicle, or it is determined in step 5036 that the above target automated guided vehicle is not in the empty-load state, the above executing body can control the above target automated guided vehicle to travel according to the to-be-traveled path taken in step 5031. Particularly, the above executing body may a control instruction corresponding to the above to-be-traveled path to the above target automated guided vehicle, and the above control instruction may include, but not limited to, at least one of: a travel direction, a travel speed and a rotation angle.

Step 5040, detecting whether the target automated guided vehicle travels into a target area.

Step 5041, changing, in response to detecting that the target automated guided vehicle travels into the target area, a state of the target area to an occupancy state.

Step 5042, detecting whether the target automated guided vehicle travels out of the target area.

Step 5043, changing, in response to detecting that the target automated guided vehicle travels out of the target area, the state of the target area to a travelable state.

Step 5044, determining whether an end point position of the to-be-traveled path is a target end point position.

In this embodiment, steps 5040-5044 may be performed in a way similar to steps 2033-2037, and thus will not be repeatedly described here.

Step 504, using a current position of the target automated guided vehicle as a start point position to re-plan the path of the target automated guided vehicle to obtain an updated path and using the updated path as the initial path to continue to perform the control steps, if it is determined in step 5036 that the target automated guided vehicle is in the empty-load state and determined in step 5037 that the other automated guided vehicle is in the load state, it is determined in step 5038 that the coincident to-be-traveled paths are occupied by the other automated guided vehicle, or it is determined in step 5044 that the end point position of the to-be-traveled path is not the target end point position.

In this embodiment, if it is determined in step 5036 that the above target automated guided vehicle is in the empty-load state and determined in step 5037 that the above other automated guided vehicle is in the load state, it is determined in step 5038 that the coincident to-be-traveled paths are occupied by the above other automated guided vehicle, or it is determined in step 5044 that the end point position of the to-be-traveled path is not the above target end point position, the above executing body may use the current position of the above target automated guided vehicle as the start point position to re-plan the path of the above target automated guided vehicle to obtain the updated path. Particularly, the above executing body may re-plan the path by using an algorithm such as a Dijkstra's algorithm or a genetic algorithm. Here, the Dijkstra's algorithm is an algorithm of calculating the shortest path from one vertex to other vertices, and accordingly, what the algorithm solves is the problem of the shortest path in a weighted graph. The genetic algorithm is a method of searching an optimal solution by simulating a natural evolution process. Then, the above executing body may use the above updated path as the initial path to continue to perform the control steps 5031-5044.

It can be seen from FIG. 5 that, as compared with the embodiment corresponding to FIG. 2, the flow 500 of the method for controlling an automated guided vehicle in this embodiment reflects the step in which, when an automated guided vehicle in an idle state conflicts with an automated guided vehicle in the load state, the path of the automated guided vehicle in the idle state is re-planned, and the step in which, when two automated guided vehicles in the idle state conflict, the path of the automated guided vehicle of which the occupancy state change time is later is re-planned. Therefore, the solution described in this embodiment can improve the travel priority of the automated guided vehicle in the load state, and thus improve the flexibility in controlling the automated guided vehicle.

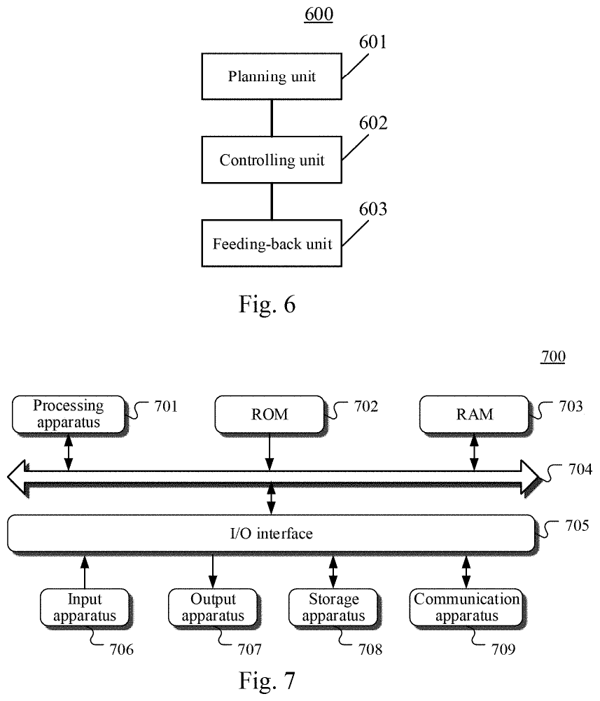

Further referring to FIG. 6, as an implementation of the method shown in the above drawings, the present disclosure provides an embodiment of an apparatus for controlling an automated guided vehicle. The embodiment of the apparatus corresponds to the embodiment of the method shown in FIG. 2. The apparatus may be applied in various electronic devices.

As shown in FIG. 6, the apparatus 600 for controlling an automated guided vehicle in this embodiment includes: a planning unit 601, a controlling unit 602 and a feeding-back unit 603. Here, the planning unit 601 is configured to plan, in response to receiving an item transportation request, a path of a target automated guided vehicle to obtain an initial path, the item transportation request comprising a target start point position and a target end point position. The controlling unit 602 is configured to perform, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position. The feeding-back unit 603 is configured to use, in response to determining that the end point position of the to-be-traveled path is not the target end point position, a current position of the target automated guided vehicle as a start point position, to re-plan the path of the target automated guided vehicle to obtain an updated path, and use the updated path as the initial path to continue to perform the control steps.

In this embodiment, for particular processes of the planning unit 601 in the apparatus 600 for controlling an automated guided vehicle, reference may be made to step 201 and step 202 in the corresponding embodiment of FIG. 2, and for particular processes of the controlling unit 602 and the feeding-back unit 603, reference may be made to step 203 and step 204 in the corresponding embodiment of FIG. 2.

In some alternative implementations of this embodiment, the above controlling unit 602 may control, in the following way, the above target automated guided vehicle to travel according to the above to-be-traveled path. The above controlling unit 602 may first change the state of the above to-be-traveled path to an occupancy state. It should be noted that the occupancy state here refers to that the above to-be-traveled path is occupied by the above target automated guided vehicle, and an other automated guided vehicle other than the above target automated guided vehicle cannot travel into the above to-be-traveled path. Then, the above controlling unit 602 may control the above target automated guided vehicle to travel according to the above to-be-traveled path. Particularly, the above controlling unit 602 may send a control instruction corresponding to the above to-be-traveled path to the above target automated guided vehicle, and the above control instruction may include, but not limited to, at least one of: a travel direction, a travel speed and a rotation angle. Then, the above controlling unit 602 may change the state of the path that the above target automated guided vehicle travels through in the above to-be-traveled path to a travelable state. Here, the above controlling unit 602 may store a layout diagram of a warehouse. In the layout diagram of the warehouse, a plurality of points may be preset, and each point corresponds to one preset first area of the warehouse. When the above target automated guided vehicle travels according to the above to-be-traveled path, every time the above target automated guided vehicle travels through a point, the above controlling unit 602 may change the state of the preset first area corresponding to the point to the travelable state. At this time, the other automated guided vehicle can travel into the target area.

In some alternative implementations of this embodiment, in the following way, the above controlling unit 602 may take, from the above initial path, at least the partial travel path including the start point position of the above initial path as the to-be-traveled path. The above controlling unit 602 may determine whether the above initial path is in the above target area. Here, determining whether the above initial path is in the above target area is generally to determine whether the whole initial path is in the above target area. If it is determined that the above initial path is in the above target area, the above controlling unit 602 may determine the above initial path as the to-be-traveled path.

In some alternative implementations of this embodiment, in the following way, the above controlling unit 602 may take, from the above initial path, at least the partial travel path including the start point position of the above initial path as the to-be-traveled path. The above controlling unit 602 may determine whether the above initial path includes a path in the above target area and includes a path outside the above target area. If it is determined that the above initial path includes the path in the above target area and includes the path outside the above target area, the above controlling unit 602 may determine whether the start point position of the above initial path is in the above target area or outside the above target area. If it is determined that the start point position of the above initial path is in the above target area, the above controlling unit 602 may take, from the above initial path, a path in the target area where the start point position of the above initial path is, to use the path as the to-be-traveled path.

In some alternative implementations of this embodiment, the above controlling unit 602 may determine whether the above to-be-traveled path is in an occupancy state. It should be noted that the occupancy state here refers to that the above to-be-traveled path is occupied by an other target automated guided vehicle, which causes the above target automated guided vehicle to be unable to travel into the above to-be-traveled path. If it is determined that the above to-be-traveled path is in the occupancy state, the above controlling unit 602 may determine whether there is an other travelable path, based on the current position of the above target automated guided vehicle, the above target end point position, and the state of each path in the preset first area. The above preset first area may be an area including various paths from the current position of the above target automated guided vehicle to the above target end point position. Particularly, the above controlling unit 602 may first determine at least one path from the current position of the above target automated guided vehicle to the above target end point position. Then, the above executing body may select, from the at least one path, an other path not including the above travelable path. Next, the above controlling unit 602 may determine whether the state of the other path is an occupancy state. If the state of the other path is the occupancy state, the above controlling unit 602 may determine whether the occupancy waiting time of the other path is greater than the occupancy waiting time of the above travel path. If it is determined that the occupancy waiting time of the other path is greater than the occupancy waiting time of the above travel path, the above controlling unit 602 may determine that there is no other travelable path. At this time, the identifier of the above target automated guided vehicle may be added to a candidate vehicle identifier set. The vehicle identifier in the above candidate vehicle identifier set is a vehicle identifier of an automated guided vehicle that is waiting because the above to-be-traveled path is occupied by an other automated guided vehicle.

In some alternative implementations of this embodiment, the above controlling unit 602 may control, in the following way, the above target automated guided vehicle to travel according to the above to-be-traveled path. The above controlling unit 602 may determine whether the state of the above to-be-traveled path is a travelable state. If it is determined that the above to-be-traveled path is changed from the occupancy state to the travelable state, the above controlling unit 602 may select, from the above candidate vehicle identifier set, a vehicle identifier meeting a preset condition. The above controlling unit 602 may select, from the above candidate vehicle identifier set, the vehicle identifier of an automated guided vehicle of which the waiting time is longest. The above controlling unit 602 may alternatively select, from the above candidate vehicle identifier set, the vehicle identifier of an automated guided vehicle with a highest priority. In order to ensure the timeliness of an order, a priority may be set for the automated guided vehicle transporting an item. Then, the above controlling unit 602 may control the automated guided vehicle corresponding to the selected vehicle identifier to travel according to the above to-be-traveled path.

In some alternative implementations of this embodiment, the above controlling unit 602 may acquire a to-be-traveled path of an other automated guided vehicle in a preset second area. Here, the above second area may include the current position of the above target automated guided vehicle. As an example, the above second area may be an area with the current position of the above target automated guided vehicle as a center point and a preset distance as a radius. The above other automated guided vehicle may be an automated guided vehicle other than the above target automated guided vehicle in the above second area. If it is detected that the above target automated guided vehicle travels in an opposite direction of the above other automated guided vehicle, the above controlling unit 602 may detect whether the to-be-traveled path of the target automated guided vehicle is coincident with a to-be-traveled path of the other automated guided vehicle. Here, the path coincidence may be a complete coincidence of the paths or a partial coincidence of the paths. If the above target automated guided vehicle travels in the opposite direction of the above other automated guided vehicle and the paths are coincident, it can indicate that the above target automated guided vehicle and the above other automated guided vehicle will have a head-on collision at some point in the future. If it is detected that the above target automated guided vehicle travels in the opposite direction of the above other automated guided vehicle and the to-be-traveled path of the above target automated guided vehicle is coincident with the to-be-traveled path of the above other automated guided vehicle, the above controlling unit 602 may acquire a state of the above target automated guided vehicle and a state of the above other automated guided vehicle. Here, the above states include an empty-load state and a load state. The empty-load state refers to that the automated guided vehicle is not loaded with goods, and the automated guided vehicle from which the goods are unloaded or to which the goods are about to be loaded is generally in the empty-load state. If it is determined that the above target automated guided vehicle is in the empty-load state and the above other automated guided vehicle is in the load state, the above controlling unit 602 may use the current position of the above target automated guided vehicle as a start point position, to re-plan the path of the above target automated guided vehicle to obtain an updated path. Particularly, the above controlling unit 602 may re-plan the path by using an algorithm such as a Dijkstra's algorithm or a genetic algorithm. Here, the Dijkstra's algorithm is an algorithm of calculating the shortest path from one vertex to other vertices, and accordingly, what the algorithm solves is the problem of the shortest path in a weighted graph. The genetic algorithm is a method of searching an optimal solution by simulating a natural evolution process. Then, the above controlling unit 602 may use the above updated path as the initial path to continue to perform the above control steps.

In some alternative implementations of this embodiment, if it is determined that the above target automated guided vehicle and the above other automated guided vehicle are in the empty-load state, the above controlling unit 602 may determine whether the coincident to-be-traveled paths are occupied by the above other automated guided vehicle. That is, if the time at which the to-be-traveled path of the above other automated guided vehicle is occupied by the above other automated guided vehicle is earlier than the time at which the to-be-traveled path of the above target automated guided vehicle is occupied by the above target automated guided vehicle, it can indicate that the coincident to-be-traveled paths are occupied by the above other automated guided vehicle. If it is determined that the coincident to-be-traveled paths are not occupied by the other automated guided vehicle, the above executing body may use the current position of the above target automated guided vehicle as the start point position, to re-plan the path of the above target automated guided vehicle to obtain the updated path. Particularly, the above executing body may re-plan the path by using an algorithm such as a Dijkstra's algorithm or a genetic algorithm. Here, the Dijkstra's algorithm is an algorithm of calculating the shortest path from one vertex to other vertices, and accordingly, what the algorithm solves is the problem of the shortest path in a weighted graph. The genetic algorithm is a method of searching an optimal solution by simulating a natural evolution process. Then, the above executing body may use the above updated path as the initial path to continue to perform the above control steps.

Referring to FIG. 7, FIG. 7 is a schematic structural diagram of an electronic device (e.g., the server shown in FIG. 1) 700 adapted to implement embodiments of the present disclosure. The electronic device shown in FIG. 7 is merely an example, and should not bring any limitation to the functions and the scope of use of the embodiments of the present disclosure.

As shown in FIG. 7, the electronic device 700 includes a processing apparatus (e.g., a central processing unit and a graphics processing unit) 701, which may execute various appropriate actions and processes in accordance with a program stored in a read-only memory (ROM) 702 or a program loaded into a random access memory (RAM) 703 from a storage apparatus 708. The RAM 703 further stores various programs and data required by the operations of the electronic device 700. The processing apparatus 701, the ROM 702 and the RAM 703 are connected to each other through a bus 704. An input/output (I/O) interface 705 is also connected to the bus 704.

Generally, the following apparatus may be connected to the I/O interface 705: an input apparatus 706 including a touch screen, a touchpad, a keyboard, a mouse, a camera, a microphone, an accelerometer, a gyroscope, or the like; an output apparatus 707 including a liquid crystal display (LCD), a speaker, a vibrator, or the like; a storage apparatus 708 including, for example, a magnetic tape, a hard disk, or the like; and a communication apparatus 709. The Communication apparatus 709 may allow electronic device 700 to wirelessly or wirelessly communicate with other devices to exchange data. Although FIG. 7 illustrates an electronic device 700 having various devices, it should be understood that not all apparatus are required to be implemented or shown. More or fewer devices may alternatively be implemented or provided.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication apparatus 709, or may be installed from the storage apparatus 708, or may be installed from the ROM 702. The computer program, when executed by the processing apparatus 701, implements the above-mentioned functionalities as defined by the method of the present disclosure. It should be noted that the computer readable medium in the embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the embodiments of the present disclosure, the computer readable storage medium may be any physical medium containing or storing programs which may be used by a command execution system, apparatus or element or incorporated thereto. In the embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The above computer readable medium may be the computer readable medium included in the above electronic device, or a stand-alone computer readable medium not assembled into the electronic device. The above computer readable medium carries one or more programs. The one or more programs, when executed by the electronic device, cause the electronic device to: plan, in response to receiving an item transportation request, a path of a target automated guided vehicle to obtain an initial path, the item transportation request comprising a target start point position and a target end point position; perform, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and use, in response to determining that the end point position of the to-be-traveled path is not the target end point position, a current position of the target automated guided vehicle as a start point position, to re-plan the path of the target automated guided vehicle to obtain an updated path, and use the updated path as the initial path to continue to perform the control steps.

A computer program code for performing operations in the embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The described units involved in the embodiments of the present disclosure may be implemented by means of software or hardware. The described units may alternatively be provided in a processor. For example, the processor may be described as: a processor comprising a planning unit, a controlling unit and a feeding-back unit. Here, the names of these units do not in some cases constitute a limitation to such units themselves. For example, the planning unit may alternatively be described as “a unit for planning, in response to receiving an item transportation request, a path of a target automated guided vehicle to obtain an initial path.”

The above description only provides an explanation of the preferred embodiments of the present disclosure and the technical principles used. It should be appreciated by those skilled in the art that the inventive scope of the embodiments of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the embodiments of the present disclosure are examples.

1. A method for controlling an automated guided vehicle, comprising:
planning, in response to receiving an item transportation request, a path of a target automated guided vehicle to obtain an initial path, the item transportation request comprising a target start point position and a target end point position;
performing, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and
using, in response to determining that the end point position of the to-be-traveled path is not the target end point position, a current position of the target automated guided vehicle as a start point position, to re-plan the path of the target automated guided vehicle to obtain an updated path, and using the updated path as the initial path to continue to perform the control steps.

2. The method according to claim 1, wherein the controlling the target automated guided vehicle to travel according to the to-be-traveled path comprises:
changing a state of the to-be-traveled path to an occupancy state;
controlling the target automated guided vehicle to travel according to the to-be-traveled path; and
changing a state of a path that the target automated guided vehicle travels through in the to-be-traveled path to a travelable state.

3. The method according to claim 1, wherein the taking, from the initial path, at least a partial travel path including a start point position of the initial path as a to-be-traveled path comprises:
determining, in response to determining that the initial path is in the target area, the initial path as the to-be-traveled path.

4. The method according to claim 1, wherein the taking, from the initial path, at least a partial travel path including a start point position of the initial path as a to-be-traveled path comprises:
determining, in response to determining that the initial path includes a path in the target area and a path outside the target area, whether the start point position of the initial path is in the target area or outside the target area; and
taking, from the initial path, a path in the target area where the start point position of the initial path is, to use the path as the to-be-traveled path, in response to determining that the start point position of the initial path is in the target area.

5. The method according to claim 1, wherein, before the controlling the target automated guided vehicle to travel according to the to-be-traveled path, the method comprises:
determining, in response to determining that the to-be-traveled path is in the occupancy state, whether there is an other travelable path, based on the current position of the target automated guided vehicle, the target end point position and a state of each path in a preset first area; and
adding, in response to determining that there is no other travelable path, an identifier of the target automated guided vehicle to a candidate vehicle identifier set.

6. The method according to claim 5, wherein the controlling the target automated guided vehicle to travel according to the to-be-traveled path comprises:
selecting, in response to determining that the to-be-traveled path is in a travelable state, a vehicle identifier meeting a preset condition from the candidate vehicle identifier set, and controlling an automated guided vehicle corresponding to the selected vehicle identifier to travel according to the to-be-traveled path.

7. The method according to claim 1, wherein, before the controlling the target automated guided vehicle to travel according to the to-be-traveled path, the method further comprises:
acquiring a to-be-traveled path of an other automated guided vehicle in a preset second area, the second area including the current position of the target automated guided vehicle;
acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the states comprising an empty-load state and a load state; and
using, if the target automated guided vehicle is in the empty-load state and the other automated guided vehicle is in the load state, the current position of the target automated guided vehicle as the start point position, to re-plan the path of the target automated guided vehicle to obtain the updated path, and using the updated path as the initial path to continue to perform the control steps.

8. The method according to claim 7, wherein, after the acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the method further comprises:
determining, if the target automated guided vehicle and the other automated guided vehicle are in the empty-load state, whether the coincident to-be-traveled paths are occupied by the other automated guided vehicle; and
using, in response to determining that the coincident to-be-traveled paths are occupied by the other automated guided vehicle, the current position of the target automated guided vehicle as the start point position, to re-plan the path of the target automated guided vehicle to obtain the updated path, and using the updated path as the initial path to continue to perform the control steps.

9. An apparatus for controlling an automated guided vehicle, comprising:
one or more processors; and
a storage apparatus, configured to store one or more programs,
wherein the one or more programs, when executed by the one or more processors, cause the one or more processors to perform operations, the operations comprising:
planning, in response to receiving an item transportation request, a path of a target automated guided vehicle to obtain an initial path, the item transportation request comprising a target start point position and a target end point position;
performing, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and
using, in response to determining that the end point position of the to-be-traveled path is not the target end point position, a current position of the target automated guided vehicle as a start point position, to re-plan the path of the target automated guided vehicle to obtain an updated path, and use the updated path as the initial path to continue to perform the control steps.

10. The apparatus according to claim 9, wherein the controlling the target automated guided vehicle to travel according to the to-be-traveled path comprises:
changing a state of the to-be-traveled path to an occupancy state;
controlling the target automated guided vehicle to travel according to the to-be-traveled path; and
changing a state of a path that the target automated guided vehicle travels through in the to-be-traveled path to a travelable state.

11. The apparatus according to claim 9, wherein the taking, from the initial path, at least a partial travel path including a start point position of the initial path as a to-be-traveled path comprises:
determining, in response to determining that the initial path is in the target area, the initial path as the to-be-traveled path.

12. The apparatus according to claim 9, wherein the taking, from the initial path, at least a partial travel path including a start point position of the initial path as a to-be-traveled path comprises:
determining, in response to determining that the initial path includes a path in the target area and a path outside the target area, whether the start point position of the initial path is in the target area or outside the target area; and
taking, from the initial path, a path in the target area where the start point position of the initial path is, to use the path as the to-be-traveled path, in response to determining that the start point position of the initial path is in the target area.

13. The apparatus according to claim 9, wherein, before the controlling the target automated guided vehicle to travel according to the to-be-traveled path, the method comprises:
determining, in response to determining that the to-be-traveled path is in the occupancy state, whether there is an other travelable path, based on the current position of the target automated guided vehicle, the target end point position and a state of each path in a preset first area; and
adding, in response to determining that there is no other travelable path, an identifier of the target automated guided vehicle to a candidate vehicle identifier set.

14. The apparatus according to claim 13, wherein the controlling the target automated guided vehicle to travel according to the to-be-traveled path comprises:
selecting, in response to determining that the to-be-traveled path is in a travelable state, a vehicle identifier meeting a preset condition from the candidate vehicle identifier set, and controlling an automated guided vehicle corresponding to the selected vehicle identifier to travel according to the to-be-traveled path.

15. The apparatus according to claim 9, wherein, before the controlling the target automated guided vehicle to travel according to the to-be-traveled path, the method further comprises:
acquiring a to-be-traveled path of an other automated guided vehicle in a preset second area, the second area including the current position of the target automated guided vehicle;
acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the states comprising an empty-load state and a load state; and
using, if the target automated guided vehicle is in the empty-load state and the other automated guided vehicle is in the load state, the current position of the target automated guided vehicle as the start point position, to re-plan the path of the target automated guided vehicle to obtain the updated path, and use the updated path as the initial path to continue to perform the control steps.

16. The apparatus according to claim 15, wherein, after the acquiring, in response to detecting that the target automated guided vehicle travels in an opposite direction of the other automated guided vehicle and the to-be-traveled path of the target automated guided vehicle is coincident with the to-be-traveled path of the other automated guided vehicle, a state of the target automated guided vehicle and a state of the other automated guided vehicle, the method further comprises:
determining, if the target automated guided vehicle and the other automated guided vehicle are in the empty-load state, whether the coincident to-be-traveled paths are occupied by the other automated guided vehicle; and
using, in response to determining that the coincident to-be-traveled paths are occupied by the other automated guided vehicle, the current position of the target automated guided vehicle as the start point position, to re-plan the path of the target automated guided vehicle to obtain the updated path, and use the updated path as the initial path to continue to perform the control steps.

17. (canceled)

18. A non-transitory computer readable medium, storing a computer program, wherein the program, when executed by a processor, causes the processor to perform operations, the operations comprising:
planning, in response to receiving an item transportation request, a path of a target automated guided vehicle to obtain an initial path, the item transportation request comprising a target start point position and a target end point position;
performing, based on the initial path, following control steps: taking, from the initial path, at least a partial travel path including a start point position of the initial path as a to-be-traveled path; controlling the target automated guided vehicle to travel according to the to-be-traveled path; changing, in response to detecting that the target automated guided vehicle travels into a target area, a state of the target area to an occupancy state, the target area comprising at least one of a preset locked area and an area between a storage position and a preset passage opening; changing, in response to detecting that the target automated guided vehicle travels out of the target area, the state of the target area to a travelable state; and determining whether an end point position of the to-be-traveled path is the target end point position; and
using, in response to determining that the end point position of the to-be-traveled path is not the target end point position, a current position of the target automated guided vehicle as a start point position, to re-plan the path of the target automated guided vehicle to obtain an updated path, and using the updated path as the initial path to continue to perform the control steps.

19. The medium according to claim 18, wherein the controlling the target automated guided vehicle to travel according to the to-be-traveled path comprises:
changing a state of the to-be-traveled path to an occupancy state;
controlling the target automated guided vehicle to travel according to the to-be-traveled path; and
changing a state of a path that the target automated guided vehicle travels through in the to-be-traveled path to a travelable state.

20. The medium according to claim 18, wherein the taking, from the initial path, at least a partial travel path including a start point position of the initial path as a to-be-traveled path comprises:
determining, in response to determining that the initial path is in the target area, the initial path as the to-be-traveled path.

21. The medium according to claim 18, wherein the taking, from the initial path, at least a partial travel path including a start point position of the initial path as a to-be-traveled path comprises:
determining, in response to determining that the initial path includes a path in the target area and a path outside the target area, whether the start point position of the initial path is in the target area or outside the target area; and
taking, from the initial path, a path in the target area where the start point position of the initial path is, to use the path as the to-be-traveled path, in response to determining that the start point position of the initial path is in the target area.
